(19) United States
(12) Patent Application Publication
(10) Pub. No.: US 2011/0005552 A1
(43) Pub. Date: Jan. 13, 2011

(54) Vehicle safety stop

(76) Inventor: Jesse W. Holmes, Linwood, CA (US)

Correspondence Address: RUTH EURE, 4795 EDISON AVENUE, BOULDER, CO, 80301, US

(21) Appl. No.: 12/803,786

(22) Filed: Jul. 6, 2010

Related U.S. Application Data
(60) Provisional application No. 61/270,121, filed on Jul. 3, 2009.

(51) Int. Cl. B08B 3/00

(52) U.S. Cl. 134/32; 134/123

(57) ABSTRACT

The present invention provides a drive-through de-icing station for tractor-trailers and other over-the-road trucks, to be offered as a safety service at truck-stops, highway rest areas, truck weighing stations, and similar, high-traffic locales. The Vehicle Safety Stop is a drive-through station somewhat similar to a car-wash, where the operative de-icing agent would comprise hot steam or liquid de-icing agent. The operative area of the Vehicle Safety Stop measures approximately 15 feet in height, 12 feet in width, and 20 to 40 feet in length. The tractor-trailer or other truck simply pulls beneath an array of strategically placed steam-heads, the configuration of which provides a thorough steam bath for the vehicle, de-icing its top, sides, and undercarriage.

### CLAIM OF PRIORITY

This patent application claims priority under 35 USC 119 (e) (1) from U.S. Provisional Patent Application Ser. No. 61/270,121 filed Jul. 3, 2009, of common inventorship herewith entitled, “Vehicle Safety Stop.”

### FIELD OF THE INVENTION

The present invention pertains to the field of truck safety devices and more specifically to the field of snow and ice removal from semi trailer trucks.

### BACKGROUND OF THE INVENTION

The prior art has put forth several designs for the removal of snow and ice from semi-trailer trucks. These include:

U.S. Pat. No. 6,453,500 to Frank Schmitt describes a vehicle roof snow removal system which comprises a main frame and a scraper assembly coupled to the mainframe. The scraper blade assembly lowers a scraper blade from the mainframe to remove snow and ice from the top of a vehicle.

U.S. Pat. No. 5,989,356 to William Candeletti describes an apparatus for removing snow accumulation from a motor vehicle roof comprising a scraper and a rotatable brush for tossing the snow from the roof of a motor vehicle.

U.S. Pat. No. 6,485,083 to Dennis Giannias describes a net safety top for flat top trailers comprising a mesh net removably affixed to a vehicle whereby the mesh net acts to restrain snow and ice from sliding off the flat top in large sheets.

U.S. Pat. No. 5,802,654 to William E. Yeaglin describes a snow and ice remover for a vehicle comprising two vertical supports separated by a distance sufficient to move a vehicle between the vertical supports and a snow plow attached to the vertical supports and located at a height which permits a vehicle to be moved under the snow plow while snow and ice on the roof of the vehicle is pushed off of the vehicle.

None of these prior art references describe the present invention.

### SUMMARY OF THE INVENTION

It is an object of the present invention to provide an improved method for removing ice and snow from a vehicle.

### BRIEF DESCRIPTION OF THE DRAWINGS

FIG. 1 is a perspective view of the device of the present invention.

FIG. 2 shows a snow covered semi trailer truck entering the frame of the present invention.

FIG. 3 shows the semi trailer truck of FIG. 2 exiting the frame of the present invention with snow and ice removed.

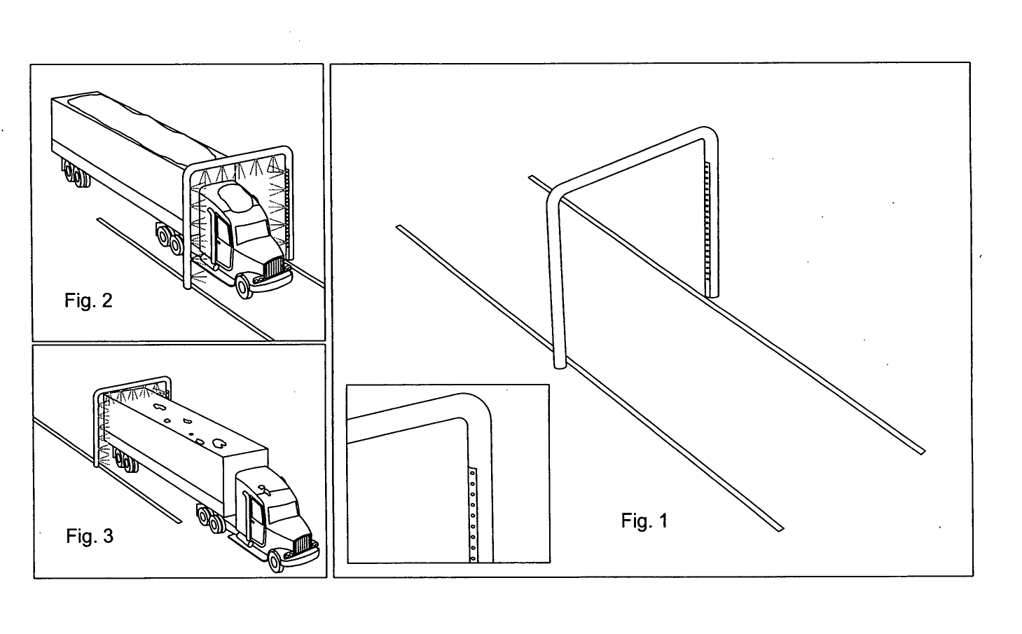

### DETAILED DESCRIPTION OF THE INVENTION

A problem occurs every winter wherein semi trailer truck rigs become covered with ice and congealed snow, and potentially lethal fragments come off the roof and undercarriage of the truck under highway conditions, and threaten the safety of motorists following them. The present invention provides a solution to correct this problem by providing a convenient and simple de-icing program for the nation's interstate truck traffic.

Recognizing the hazard that motorists face when an iced-up truck sheds its frozen cargo under highway conditions, the present invention, hereinafter referred to as the Vehicle Safety Stop, was developed. Simply stated, the Vehicle Safety Stop comprises a drive-through de-icing station for tractor-trailers and other over-the-road trucks, to be offered as a safety service at truck-stops, highway rest areas, truck weighing stations, and similar, high-traffic locales. The Vehicle Safety Stop is a drive-through station somewhat similar to a car-wash, where the operative de-icing agent would comprise hot steam or liquid de-icing agent. The operative area of the

Vehicle Safety Stop measures approximately 15 feet in height, 12 feet in width, and 20 to 40 feet in length. The tractor-trailer or other truck simply pulls beneath an array of strategically placed steam-heads, the configuration of which provides a thorough steam bath for the vehicle, de-icing its top, sides, and undercarriage.

In one embodiment, the steam-heads are activated by a pressure-plate which triggers a switch as a truck passes over it.

In an alternative embodiment, motion sensors detect the oncoming vehicle, thereby actuating the emission of the de-icing agent.

In a further alternative embodiment, light sensors interrupted by the entry of the truck actuate the emission of the de-icing agent.

In any case, the Vehicle Safety Stop is a fully automated de-icing station. The Vehicle Safety Stop stations can be financed by the trucking companies, by the various state highway departments, the US Department of Transportation, or by other public and private entities.

The Vehicle Safety Stop, a system of roadside de-icing stations for over-the-road trucks, presents a number of distinct and significant benefits and advantages. Foremost, the Vehicle Safety Stop removes accumulated ice and snow from the roofs and undercarriages of trucks before these vehicles get on the road, where the ice and snow may break free of the vehicle and endanger other motorists. A simple roadside de-icing station, the Vehicle Safety Stop is a safety drive-through for trucks, and is positioned strategically at weigh stations, rest areas, truck-stops, and other locations frequented by trucks. Here, prior to getting back on the road, the trucker simply drives his or her rig beneath the steam-heads of the Vehicle Safety Stop, then remains in idle for a few moments while the automated steam-heads go to work on the top, sides, and roof of tractor and trailer to melt any accumulated snow and ice.

The process takes very little time, and once done, the truck enters the roadway completely free of ice and snow, and therefore free of the materials which might otherwise break away from the truck under speed and become lethal projectiles to other vehicles on the road. This strategically positioned, fully automated system greatly enhances the safety of the motoring public, much as aircraft de-icing procedures have enhanced the safety of the flying public.

A drive-through steam-cleaning system to be employed on tractor-trailers and other large over-the-road vehicles in winter, the Vehicle Safety Stop is positioned at intervals along access ramps, weighing stations, etc., along the Interstate highways, and thus enable truck operators to remove ice and snow from the roofs of their rigs, thereby eliminating a potentially lethal hazard to other motorists. The. Vehicle Safety Stop greatly enhances highway safety in winter, and will find a wide and receptive audience among the motoring public.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A device for removing snow and ice from a vehicle, comprising a drive-through de-icing station for tractor-trailers and other over-the-road trucks, to be offered as a safety service at truck-stops, highway rest areas, truck weighing stations, and similar, high-traffic locales, further comprising a drive-through station somewhat similar to a car-wash, where the operative de-icing agent comprises hot steam or liquid de-icing agent.

2. The device of claim 1, further comprising an operative area that measures approximately 15 feet in height, 12 feet in width, and 20 to 40 feet in length.

3. A method of de-icing a vehicle comprising:
the vehicle drives beneath an array of strategically placed steam-heads, the configuration of which provides a thorough steam bath for the vehicle, de-icing its top, sides, and undercarriage.
